(19) United States
(12) Patent Application Publication
(10) Pub. No.: US 2008/0136123 A1
(43) Pub. Date: Jun. 12, 2008

(54) Gasket for Sealing a Connection Between Two Molded Parts

(75) Inventors: Jean-Philippe Angot, Change (FR); Philippe Trotin, Quelainsves (FR)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GmbH, Ludwigsburg (DE)

(21) Appl. No.: 12/032,511

(22) Filed: Feb. 15, 2008

Related U.S. Application Data
(62) Division of application No. 11/197,257, filed on Aug. 5, 2005.
Application No. 11/197,257 is a continuation of application No. PCT/EP2004/050120, filed on Feb. 12, 2004.

(30) Foreign Application Priority Data
Feb. 13, 2003 (DE) 103 06 211.4

(51) Int. Cl. F16J 15/32

(52) U.S. Cl. 277/650

(57) ABSTRACT

ABSTRACT OF THE DISCLOSURE A gasket, in particular a valve-cover or cylinder-head cover seal, for sealing a connection between a substantially thin-walled, molded part and an additional molded part. The gasket includes an elastic sealing lip which is disposed between the two molded parts, and the elastic sealing lip is molded onto the outer edge region of a dimensionally stable support frame.

### CROSS REFERENCE TO RELATED APPLICATIONS

This application is a division of co-pending application Ser. No. 11/197,257, filed Aug. 5, 2005, which in turn was a continuation of international patent application No. PCT/EP2004/050120, filed Feb. 12, 2004, designating the United States of America, and published in German on Aug. 26, 2004 as WO 2004/072515, the entire disclosure of which is incorporated herein by reference. Priority is claimed based on Federal Republic of Germany patent application No. DE 103 06 211.4, filed Feb. 13, 2003.

### BACKGROUND OF THE INVENTION

The invention relates to a gasket, particularly a valve cover gasket, for sealing a connection between two molded parts having an elastic sealing lip disposed between the two molded parts.

Thin-walled molded parts, such as valve covers or cylinder head covers for internal combustion engines, have elastic or resilient gaskets to provide a seal when they are connected with other molded parts. Published United Kingdom patent application No. GB 2,328,990 (=DE 197 38 275) discloses an elastic gasket for the static sealing of thin-walled covers of internal combustion engines. The thin-walled cover has a circumferential mounting flange with a circumferential groove intended to receive the elastic gasket. It is proposed to provide the elastic gasket with projections that encompass the outer rim of the mounting flange, such that hook-shaped collars reach behind the mounting flange. This achieves a positive clamping of the gasket on the cover. A drawback is the relatively complex construction of the gasket with the hook-shaped collar and the projections as well as the time-consuming mounting of the gasket to the thin-walled cover. The gasket, adapted to the shape of the cover, must be carefully fastened to the cover following the contour. To prevent leaks, it is necessary to ensure the encompassing of the flange at each point along the contour of the cover.

Published German patent application No. DE 41 25 344 discloses a metal-reinforced molded rubber gasket for mutually sealing two molded parts that are pressed together by screw bolts. The gasket consists of a vulcanized sheet metal support, such that the vulcanized rubber layer has longitudinally extending sealing beads and sealing lips that circle the screw holes on one side traversing the gasket on the inside. Such metal-reinforced molded rubber gaskets are used, in particular, to sealingly mount sheet metal covers or similar molded castings. A drawback is the mixture of metal and plastic, especially since these gaskets are usually intended as replaceable gaskets and recovery or recycling is much more difficult as a result. The mixture of materials also has a negative impact on production and hence on the production costs.

U.S. Pat. No. 4,819,953 (=DE 36 39 218) discloses a device in which thermally softened gasket material is injection molded onto the marginal portion of the valve cover to form the gasket with at least one coupling agent applied therebetween. After cooling, the gasket in its cooled form adheres to the marginal portion of the cover. The marginal portion of the valve cover simultaneously acts as one part of the die that is required to form the gasket. Although this gasket facilitates handling in connection with the valve cover because it requires no gasket to be inserted following a complex contour and held until the connection is established, but it has the significant drawback that when the two molded parts are separated, the reinsertion of a new, unused gasket is complicated and time-consuming. The old gasket must be removed from the valve cover without residue and a new gasket must again be injection molded in a heated state. This process is costly and time-consuming and requires a great deal of care when the gasket is replaced.

### SUMMARY OF THE INVENTION

It is therefore an object of the present invention to provide an improved gasket for sealing a connection between two molded parts.

Another object of the invention is to provide a gasket that is easy to replace, simple and cost-effective to manufacture and has a better functionality.

These and other objects are achieved in accordance with the present invention by providing a gasket for sealing a connection between a substantially thin-walled molded part and an additional molded part, said gasket having an elastic sealing lip disposed between the two molded parts, wherein said elastic sealing lip is injection molded onto an outer marginal portion of a stably-shaped support frame. Advantageous further refinements and preferred embodiments are described in more detail hereinafter.

The gasket according to the invention serves to seal a joint between a substantially thin-walled molded part and another molded part. The gasket has an elastic sealing lip which is arranged between the two molded parts. Furthermore, the elastic sealing lip is injection molded onto the outer portion of a shape-stable support frame. A gasket of this type is suitable particularly for valve cover gaskets or cylinder head gaskets of an internal combustion engine. However, the gasket according to the invention can also be used wherever two parts must be sealingly connected with each other. The gasket according to the invention is especially advantageous when the two molded parts have complex contours because the elastic sealing lip conforms to the predefined shape of the molded parts since it is connected to the stably-shaped support frame and is therefore very easy and quick to apply.

The sealing lip has a preferably oval shape tapering toward the faces which seat with the molded parts, but a round or angular basic form is also feasible. To enable the sealing lip to compress when the two molded parts are assembled, it is thicker than the shape-stable support frame. The deformation of the sealing lip when the two molded parts are assembled compensates for minor unevennesses in the sealing face of the molded parts and thus provides a tight fit over the entire area of the sealing faces of the two molded parts to ensure a reliable seal. The stably-shaped support frame is made of a firm, non-elastic dimensionally-stable material and thus holds the elastic sealing lip in a predetermined shape.

To increase the stability between the longitudinal sides of the support frame, the support frame preferably has connecting segments that are made of the same material. These are optional, however, and are not absolutely necessary for the function of the gasket and the supporting aid provided by the support frame.

The gasket design according to the invention facilitates the insertion of the gasket into the molded parts which correspond for this purpose, particularly since unlike in the prior art where a soft gasket must follow a partly complex contour of the sealing face of the molded parts, in the present invention the support frame has exactly the same contour, so that the elastic sealing lip can be inserted into the contour precisely and quickly. This also prevents any incorrect insertion or squashing of an imprecisely inserted gasket. The gasket according to the invention is therefore particularly suitable for valve cover gaskets and cylinder head cover gaskets. As described above, however, it may also be used, for example, for air filter housing covers or oil pan gaskets.

In one preferred embodiment of the gasket according to the invention, the sealing lip is made of an elastomer and the support frame of a thermoplastic material. The elastomer portion may be a synthetic rubber and the thermoplastic portion a polyamide, for example. It is preferred to use materials known to those skilled in the art, which have a certain resistance to aggressive media, such as oils, greases or aerosols. Because of this material combination of the gasket, it is particularly easy to reproduce complex contours of the sealing face of the molded parts by injection molding using a suitable tool. In a first step, the stably-shaped thermoplastic support frame is injection molded in the mold, and in the second step the elastic sealing lip is then injection molded onto the outer portion of the frame. This provides a shape-stable and easily applied gasket with a soft, well-sealing outer circumferential sealing lip.

In accordance with another advantageous embodiment of the gasket according to the invention, the support frame has means for the detachable corresponding connection of the gasket with one of the molded parts. The detachable corresponding connection can be realized by using a clip system, expansion pins or screws. A tool-less connection that requires no additional parts is preferred, however. To this end, openings may be provided to receive flexible hooks or the like which are formed in the molded part to correspond to the openings. When equipped in this manner, the gasket according to the invention is secured against falling out if it needs to be transported together with one of the molded parts to the assembly location where it is joined to the second molded part, or the joining of the two molded parts in an exposed position is simplified. Thus, in a difficult mounting position, for example, there is no need to take care that the gasket does not slip or fall out just before assembly.

A special embodiment of the gasket according to the invention includes at least one indicator on the side of the sealing lip, which indicates that a seal is inserted between the two joined parts. The indicator extends substantially parallel to the parting plane between the two molded parts and preferably comprises a lateral extension of the sealing lip. However, it is also feasible to additionally injection mold an indicator onto the sealing lip.

Since, in the prior art, the gasket is inserted into grooves made in the sealing face of the molded parts, there is no visible evidence after the two molded parts are assembled to indicate whether a gasket is inserted between the molded parts. An inadvertent omission of a gasket may result in serious engine damage, which can be prevented by the indicator proposed here. With the indicator it is possible to determine from the outside beyond any doubt whether there is a gasket inserted between the two molded parts even after the molded parts have been assembled. The indicator is guided outwardly through a corresponding opening in at least one of the molded parts to show visible evidence of the presence of a gasket.

In accordance with another advantageous embodiment of the gasket according to the invention, at least one functional component is arranged on the support frame by means of at least one detachable connection. The presence of the support frame makes it possible to arrange functional components, such as oil traps for the removal of oil from aerosols, valves for the controlled opening of a passage or other means to integrate additional functions on the support frame. These functional components may be detachably connected with the support frame within the range of action of the sealing lips along the inner portion of the support frame. The connection may be effected with screws, clips, bayonet catches or other fastening means known in the art.

In accordance with yet another embodiment of the gasket according to the invention, the at least one functional component is integrated directly into the support frame and is formed together with the support frame directly during the injection molding process. This may include, for example, plastic baffles or simple umbrella valves, which are not costly and can be disposed of when the gasket is replaced. Because the material is the same, recycling is not an issue. It is also possible to inject functional elements made of the same or a different material into the support frame or to attach them permanently to the support frame using a welding or adhesive bonding process.

In accordance with yet another embodiment of the invention, the gasket is inserted between two molded parts, and the molded parts are correspondingly interconnected by screw connections. Thus, the seal surrounds the through-holes formed in the molded parts for the passage of the screws on all sides. In other words, gasket openings are provided in the gasket contour, which correspond to the openings in the molded parts for the screw bolts. This provides additional centering and securing of the gasket and an advantageous sealing of the connection.

In another modification of the gasket according to the invention, the range of action of the gasket extends along the inside of the through-holes made for the screwed connections in the two molded parts. Thus, the sealing lip seals the volume between the two molded parts also relative to the through-holes that are provided for screwing the two parts together.

In another variation of the gasket according to the invention, the range of action of the sealing lip runs past the through-holes on the outside so that the through-holes are included in the seal relative to the outside. Here, the bores of the through-holes are to be individually sealed in addition relative to the outside, so that no leaks can occur in this area.

In a special embodiment of the invention, the support frame is substantially plate-shaped, such that the elastomer gasket is arranged along the margin and the support frame has at least one passage between the two molded parts. In special applications it is useful to limit the passage between the two molded parts. This makes it possible, for example, to inhibit the foaming of oil or escaping of a heavily oil-laden aerosol. With a corresponding configuration of the size and arrangement of the at least one passage in the support frame, such cases can be minimized or avoided entirely. To this end the plate-shaped part of the support frame can also be slit, perforated or provided with a three-dimensional contour, so that production in a standard injection mold is readily possible.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawing figures, in which:

FIG. 1 is an isometric view of a gasket according to the invention;

FIG. 2 is an enlarged cross-sectional detail view taken in the area of the sealing lip;

FIG. 3 is an isometric view of the assembly of the gasket according to the invention with a thin-walled molded part, and FIG. 4 is a representation of a gasket according to the invention with integrated functional components.

### DETAILED DESCRIPTION OF PREFERRED EMBODIMENTS

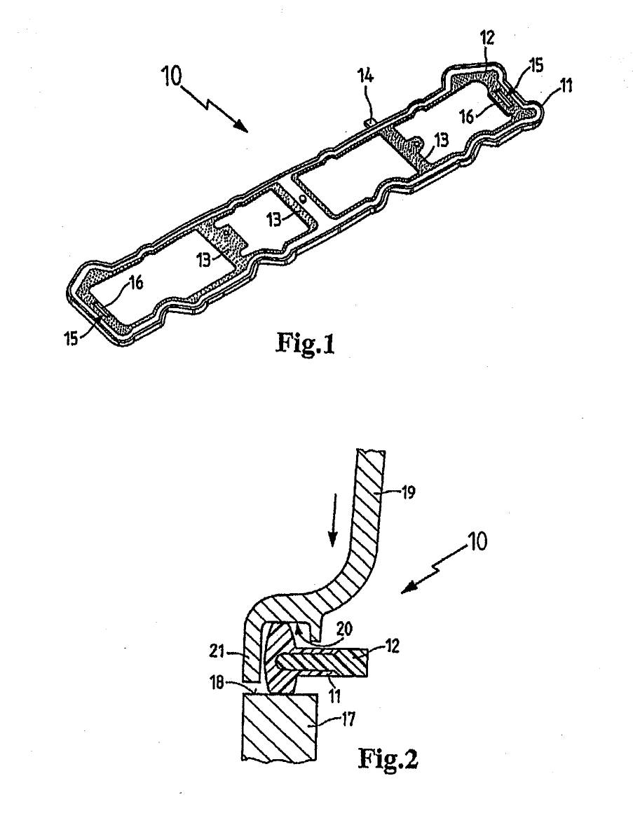

FIG. 1 depicts an embodiment of the gasket 10 according to the invention with an elastic sealing lip 11, which is injection molded onto a support frame 12. The elastic sealing lip 11 has a specific outer contour, which is matched or adapted to the contour of the corresponding molded parts. In the interior portion of the gasket 10, center segments 13 are formed in the support frame 12 to enhance the stability of the gasket 10 as a whole. The height of the sealing lip 11 starting from the gasket plane substantially exceeds the thickness of the support frame 12. This ensures that when the two molded parts are assembled with the inserted gasket, the sealing lip can be compressed at each point of its contour. Along the outer circumference of the sealing lip 11, an indicator 14 is arranged. This indicator 14 is injection molded onto the support frame 12 in the mold together with the sealing lip 11. It does not interrupt the sealing lip, so that the sealing action is the same in this area as in any other area. Clip openings 15 are disposed on the opposite narrow sides of the support frame. These clip openings 15 in the form of a transverse slot each have a transverse segment 16. These transverse segments 16 serve to receive a corresponding fastening means of one of the molded parts.

FIG. 2 is a cross-sectional view of an enlarged detail of the gasket 10 according to the invention in its installed state. Components corresponding to those of FIG. 1 are identified by the same reference numerals. The sealing lip 11 rests on a molded part 17, such as a camshaft housing, for example, and is slightly compressed in the area of the seating face 18 on the molded part 17. A cover 19 corresponding to the molded part 17 and having a groove 20 to receive the sealing lip 11 is mounted. In the area of the receiving groove 20, the upper portion of the sealing lip 11 is enclosed by the receiving groove 20. It is slightly compressed here, like in the area of the seating face 18, and thereby connects the molded part 17 with the cover 19 so as to provide a seal. When the cover 19 and the molded part 17 are joined in the direction of the arrow, an outer leg 21 of the cover 19 pushes against the seating face 18 of the molded part 17. This figure, too, shows the difference in the thickness between the sealing lip 11 and the support frame 12 relative to the plane of the gasket 10.

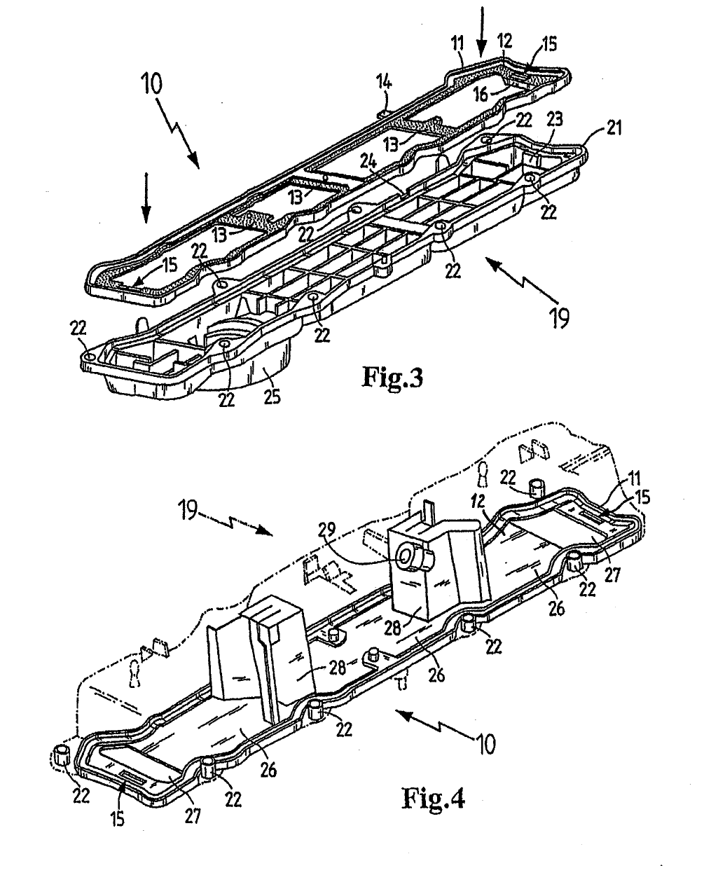

FIG. 3 shows the gasket according to the invention in the process of being connected to a cover. Components corresponding to those shown in FIG. 1 are identified by the same reference numerals. The gasket corresponds to the gasket described with reference to FIG. 1. The contour of the gasket 10 correspondingly follows the contour of the cover 19. To connect the cover 19 with the molded part 17 (not shown), a plurality of through-holes 22 are provided circumferentially in the outer portion. As may be seen, the sealing lip extends on one side past the inside of the through-holes 22, such that a separate seal for the through-holes 22 is not required. A retaining pin 23 is arranged in the center region of the opposite margins of the narrow sides of the cover 19. This retaining pin 23 is designed to correspond to the clip opening 15 of the gasket 10 according to the invention. When the gasket 10 is inserted into the cover 19 in the direction of the arrow, the retaining pin 23 pushes through the clip opening 15 and then hooks into the cross segment 16. The cover 19 and the gasket 10 are thereby interconnected, and there is no risk that the gasket 10 will fall out during assembly of the cover 19 that includes the inserted gasket 10 with the molded part 17, or that it will be damaged during assembly. If the gasket 10 needs to be replaced after use, the cover 19 including the inserted gasket 10 is unscrewed from the molded part 17, and the gasket 10 can be detached from the cover 19 without destroying it by pushing the retaining pins 23 apart. The rear longitudinal portion of the circumferential outer leg 21 has an indicator opening 24, which is designed to correspond to the indicator 14 arranged on the gasket 10. Thus, after assembly, it is readily visible from the outside whether a gasket has been inserted. In this figure, the cover 19 is a flat cover used to cover a camshaft housing, for example, and is moreover provided with an oil-pouring hole 25.

FIG. 4 shows a variant of the gasket according to the invention with integrated functional elements. Components corresponding to those of FIG. 1 are identified by the same reference numerals. In this figure, the cover 19 is already connected to the gasket 10. To make the representation clearer, the cover 19 over the underlying parts is indicated by a phantom line. The contour of the gasket 10 again extends on one side past the through-holes 22 along the inside, so that no separate seal for the through-holes 22 is required. As can be seen from FIG. 4, the support frame 12 comprises a plate 26 which extends substantially continuously between passage apertures 27 arranged adjacent each of the respective longitudinal ends of the support frame. The longitudinal sides of the gasket 10 are connected not by cross segments 16 but by the continuous plate 26. The plate 26 is made of the same material as the support frame 12 and is injection molded together with the support frame in a single process step. Along the outer ends of the gasket 10, there are passages 27, which admit a gas flow, e.g., of crankcase gases, into the volume enclosed by the cover 19. The oil laden gases flowing through the passage 27 into the volume enclosed by the cover 19 flow through two air de-oiling elements 28, such that the oil contained in the gas in the form of droplets is deposited along these air de-oiling elements 28 and flows back into the subjacent volume across the plates 26 and through the passage 27. Thereafter, the gases leave the volume enclosed by the cover 19 through a ventilation port 29 and are fed, for example, into the intake system of the internal combustion engine. In this example, the air de-oiling elements 28 are thus functional components integrated into the gasket 10, which have been injection molded together with the plate 26 directly when the support frame 12 was produced. The air de-oiling elements 28 should be understood as a kind of labyrinth for the gas flowing through, such that the oil droplets are deposited along the walls of the air de-oiling elements 28 that guide the gas. The plate 26 serves to separate the volume enclosed by the cover 19 from the volume underneath the plate 26 in the molded part 17 to calm the gas flowing through and to isolate it from any oil spatters that may occur in the lower volume of the molded part. This view actually shows two different functional components in the gasket 10: the air de-oiling elements 28 on the one hand and the protective plates 26 on the other.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A gasket for sealing a connection between a substantially thin-walled molded part and an additional molded part, said gasket having an elastic sealing lip adapted for disposal between the two molded parts, wherein said elastic sealing lip is injection molded onto a stably-shaped support frame, wherein in a continuous plate is molded together with the support frame so that the continuous plate and the support frame interconnect longitudinal sides of the gasket, wherein the gasket is arranged along an outer margin of the support frame, wherein the continuous plate is provided with at least one through opening between the two molded parts, and wherein at least one air de-oiling element is directly and permanently integrated into the support frame.

2. A gasket according to claim 1, wherein the sealing lip is made of an elastomer and the support frame of a thermoplastic material.

3. A gasket according to claim 1, wherein the support frame is provided with means for detachably and matingly connecting the gasket to one of the molded parts.

4. A gasket according to claim 1, further comprising at least one indicator disposed on a side of the sealing lip to indicate the presence of an inserted gasket when the molded parts are assembled.

5. A gasket according to claim 1, wherein the at least one air de-oiling element is directly and permanently integrated into the continuous plate.

6. A gasket according to claim 1, wherein the two molded parts are correspondingly interconnected by a screwed connection, and the gasket surrounds through-holes formed in the molded parts for the passage of the screws on all sides.

7. A gasket according to claim 1, wherein the two molded parts are correspondingly interconnected by a screwed connection, and the gasket extends along one side on the inside past through-holes formed in the molded parts for the passage of the screws and thereby seals the holes from the interior of the molded parts.

8. A gasket according to claim 1, wherein the two molded parts are correspondingly interconnected by a screwed connection and the gasket extends along the outside past through-holes formed in the molded parts for the passage of the screws.

9. A gasket according to claim 1, wherein said gasket is a valve cover gasket interposed between a thin-walled, molded valve cover and a camshaft housing.

10. A gasket according to claim 1, wherein the continuous plate and the support frame are integrally molded together in a single piece.
